(19) United States
(12) Patent Application Publication
(10) Pub. No.: US 2017/0075880 A1
(43) Pub. Date: Mar. 16, 2017

(54) TRANSLATION FOR WEB SERVICES

(71) Applicants: Hui WANG, Shanghai (CN); Meng-Dan ZHU, Shanghai (CN); Qing-Yi WANG, Shanghai (CN); HEWLETT-PACKARD DEVELOPMENT COMPANY, L.P., Houston, TX (US)

(72) Inventors: Hui Wang, Shanghai (CN); Meng-Dan Zhu, Shanghai (CN); Qing-Yi Wang, Shanghai (CN)

(21) Appl. No.: 15/120,447

(22) PCT Filed: Apr. 30, 2014
(86) PCT No.: PCT/CN2014/076593

§ 371 Date: Aug. 19, 2016

(51) Int. Cl. G06F 17/28; H04L 29/06; H04L 29/08; G06F 17/22; G06F 17/30; H04L 29/10

(52) U.S. Cl. CPC G06F 17/289; H04L 67/42; H04L 67/02; G06F 17/2247; G06F 17/30893; G06F 17/30896; G06F 17/30905; H04W 88/02

(57) ABSTRACT

An example method includes receiving, by a translator on a user device, a client request from a user of the user device, the client request being associated with a web service; identifying a translation pattern corresponding to the client request from a plurality of translation patterns; generating a translated client request based on the client request and the translation pattern corresponding to the client request, and transmitting the translated client request to the web service.

### BACKGROUND

Web applications and web pages are accessed by a variety of devices, such as laptops, desktops and tablets, for example. Such web services are typically accessed through a network, such as the Internet, as hypertext markup language (HTML) files that are translated into web pages by browsers on the devices

### BRIEF DESCRIPTION OF THE DRAWINGS

For a more complete understanding of various examples, reference is now made to the following descriptions taken in connection with the accompanying drawings in which.

FIG. 1 illustrates an example system for translation of web services,

FIG. 2 illustrates an example translation engine for translating a client request for a web service;

FIG. 3 illustrates an example process for translation of a client request for a web service,

FIG. 4 illustrates an example translation engine for translating content from a web service, and

FIG. 5 illustrates an example process for translation of content from a web service

### DETAILED DESCRIPTION

Various examples described below provide for translation between mobile devices and web services which may not have migrated to a mobile platform In this regard, examples described herein allow for users to access legacy web services (e g, web pages or web applications configured for access by desktop computers) using a mobile device, such as a smartphone or a tablet A translation engine may be provided on the mobile device to access patterns which provide translation between the mobile platform of the user's device and the legacy platform of the web service. The translation engine may translate client requests from the user into legacy client requests to be sent to the web service such that it may appear to the web service that the client request is coming from a legacy device. Similarly, the translation engine may translate content from the web service into a format suitable for display on the mobile device

As described above, various web services, including web applications and web pages, are accessible by various devices Increasingly, such devices are becoming mobile devices. Accordingly, more and more web services are migrating to a mobile platform. For example, many websites provide a mobile version. In this regard, the mobile device may communicate with the web service by exchanging data in JavaScript Object Notation (NON) format Thus, the web service is capable of communicating with the mobile device in a compatible manner.

Many legacy web services have been developed for use by legacy devices, such as laptops or desktops. Such legacy web services may be configured to, for example, communicate with the user devices by transferring information in hypertext markup language (HTML) or extensible. markup language (XWL). Legacy web services may not be maintained or updated for communication on a mobile platform. Thus, the user may be provided with an undesirable user experience when accessing such legacy web services. Examples described in the present disclosure provide devices and methods which allow users of mobile devices to access legacy web services in a desirable manner

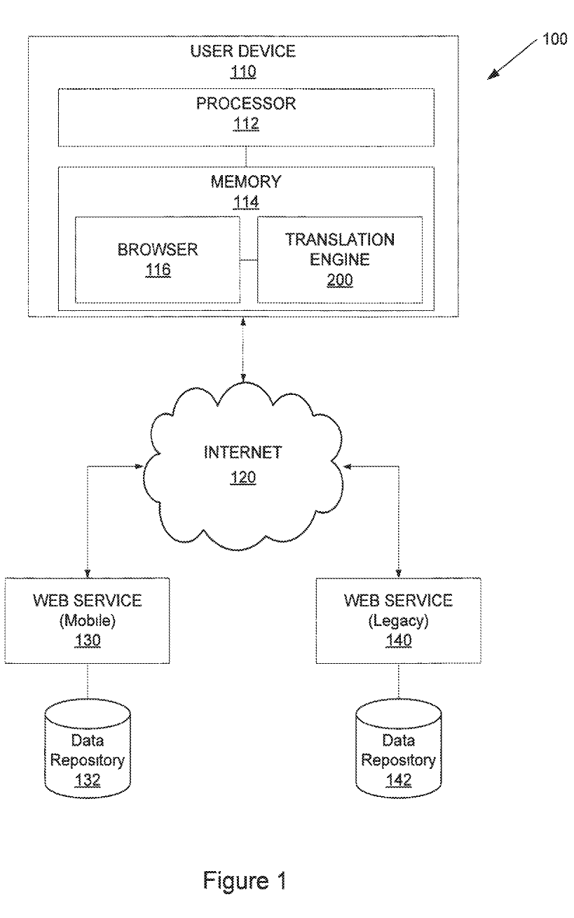

Referring first to FIG. 1, an example system for translation of web services is illustrated The example system 100 includes a user device 110 which includes a processor 112 and a memory unit 114 The user device 110 may be any electronic device suitable for electronic communication. In one example, the user device 110 is a mobile device such as a smart phone, a tablet, a personal digital assistant or the like. The memory unit 114 may be any of variety of types of storage devices, such as flash memory, solid state memory, or any other non-transitory storage device Those skilled in the art will appreciate that the user device 110 may contain a variety of other components not illustrated in the example of FIG. 1. For example, the user device 110 may include a power supply, an antenna and one or more transceivers for wireless communication

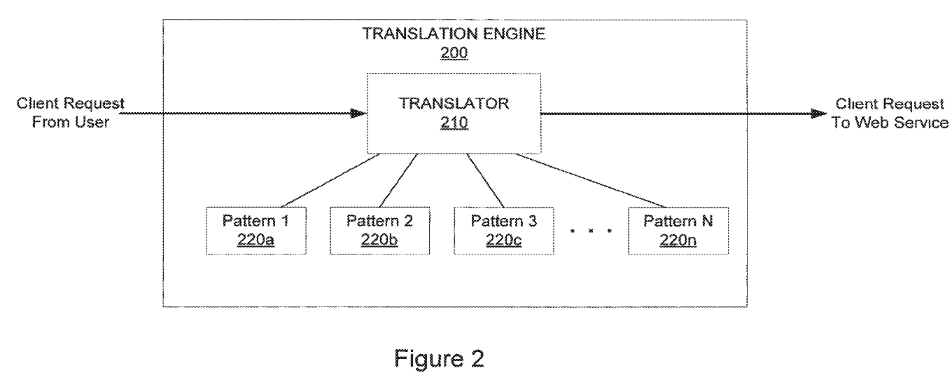

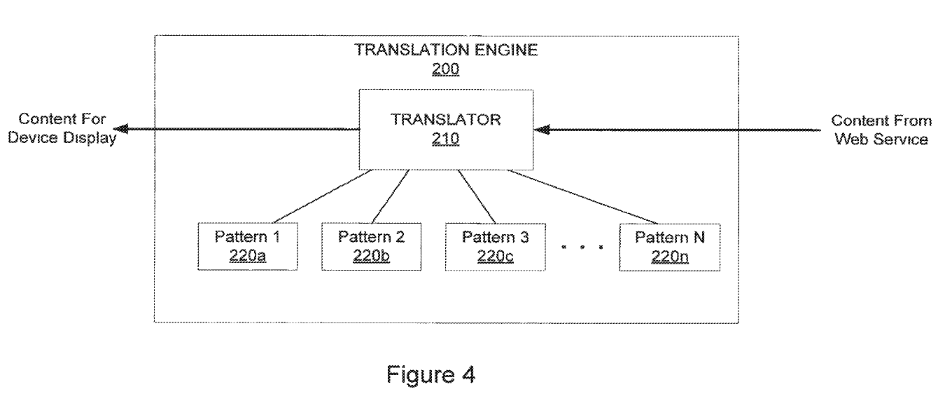

In the illustrated example, the user device 110 is provided with a web browser 110, such as Internet Explorer, Safari, or Firefox, for example, for interfacing with various web services In other examples, the user device 110 may be provided with other methods of interfacing with web services The example user device 110 of FIG. 1 is also provided with a translation engine 200 An example translation engine 200 is described below in greater detail with reference to FIGS. 2 and 4 In the example of FIG. 1, the translation engine 200 is illustrated as being separate from the web browser 116 In other examples, the translation engine 200 may be implemented as a part of the web browser 116, such as a plug-in to the browser

Through the web browser, the example user device 110 may access a web service that may be hosted on one or more servers As illustrated in FIG. 1, in various examples, the web services may be accessed through a network such as the Internet 120. In other examples, the network may be a local network, or an intranet The user device 110 may access various web services, including web services configured for a mobile platform, such as the web service 130, or web services configured for a legacy platform, such as the web service 140. Through the web services 130, 140, the user device 110 may also access data stored in associated data repositories 132, 142, respectively.

Referring now to FIG. 2, an example translation engine is illustrated for translating a client request for a web service As described below with reference to FIG. 4, the same or similar translation engine may be used for translating content from a web service for display by the user device In the example of FIG. 2, the translation engine 200 includes a translator 210 and a set of translation patterns 220a-n The translator 210 of the translation engine 200 may receive a client request, such as an input from the user of the user device 110 through the web browser 116, for example The client request may be a selection on the browser of a particular web service, such as a web page or a web application. The client request may be received in various forms, such as a URL or a selection on a particular web page. For example, the client request may be a selection of a pull-down menu on a web page or other such input by the user

In various examples, the translator 210 may use the client request to identify a pattern from the group of patterns 220a-n which corresponds to the client request In some examples, each pattern in the group of patterns 220a-n corresponds to a single web page In other examples, each pattern corresponds to a single web service.

In one example, each pattern is setup by a page name and a page list. The page list may contain various page objects. Each page object may include various attributes. The attributes may include a unique name of the page, as well as the page URL to which the page is posted The page object may be assigned a service name used by the translator to call the pattern Example page objects may also include the appropriate method (e g, post or get) and various get parameters and/or post parameters used in a corresponding trip request. In various examples, the page object may identify one or more patterns associated with the page object

Further, the example illustrated in FIG. 2 includes the translator 210 and the patterns 220a-n stored on the user device 110 In other examples, the translator 210 may be provided on the user device and at least some of the patterns 220-n are provided on a separate device, such as an intermediate server or a separate web service, for example

The example translator 210 may use the client request from the user and the corresponding pattern to generate a translated client request In various examples, the pattern may provide a mapping from a JSON input from the user to an HTML input for the legacy web service, for example The translator may also include user-provided information to form the translated client request For example, the client request from the user may include a user identifier and/or password in JSON format The translator 210 may generate the translated client request in HTML firmat and may include the user identifier and/or password in the translated client request The translated client request may be transmitted to the web service through, for example, a transceiver (not shown) of the user device 110.

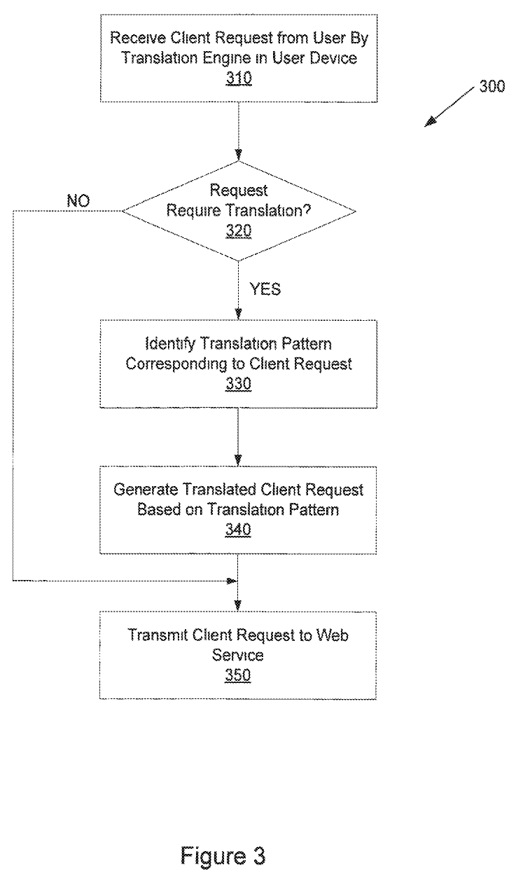

Referring now to FIG. 3, an example process for translation of a client request for a web service is illustrated The example process 300 begins with the translation engine in the user device receiving a. client request from the user (block 310) As noted above, the client request may be received in JSON format and may be received through the web browser of the user device The translation engine may determine if the client request requires translation (block 320) For example, if the client request is associated with a web service which is available in a mobile format, no translation may be required. Otherwise, if the client request is associated with a legacy web service, for example, the process may proceed to block 330, and a translation pattern from a set of patterns may be identified as corresponding to the client request For example, a pattern corresponding to the web service associated with the client request may be identified.

The translation engine may use the client request and the translation pattern corresponding to the client request to generate a translated client request (block 340) For example, as described above with reference to FIG. 2, the translated client request may be in HTML format for transmission to the legacy web service and may include information provided by the user, such as user identifier and password. The translated client request may then be sent to the legacy web service (block 350).

Referring now to FIG. 4, an example translation engine 200 for translating content from a legacy web service for presentation on a mobile device, fix example, is illustrated As noted above, the translation engine for translating content from the legacy web service may be the same or similar translation engine 200 illustrated above in FIG. 2 for translating a client request for transmission to the web service.

In the example of FIG. 4, similar to the example of FIG. 2, the translation engine 200 includes the translator 210 and the set of translation patterns 220a-n. In various examples, the same patterns 220a-n may be used for both translating client requests and translating content from the web service. In the example of FIG. 4, the translator 210 of the translation engine 200 may receive content from the legacy web service, such as HTML code associated with a web page, for example

In various examples, the translator 210 may use the web service and/or the content from the web service to identify a pattern from the group of patterns 220a-n which corresponds to the content. As noted above, in some examples, each pattern in the group of patterns 220a-n corresponds to a single web page. In other examples, each pattern corresponds to a single web service

The example translator 210 may use the content from the web service and the corresponding pattern to generate translated content. In various examples, the pattern may provide a mapping from an HTML web page from the web service to JSON content for the mobile platform, for example. The translated content may be provided to the web browser for displaying on the user device.

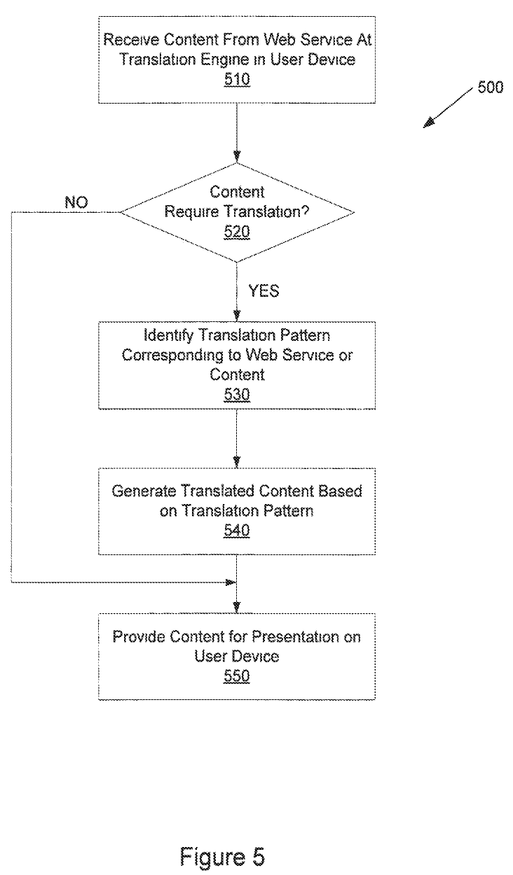

Referring now to FIG. 5, an example process for translation of content from a web service for a mobile platform, for example, is illustrated. The example process 500 begins with the translation engine in the user device receiving content from the web service (block 510). As noted above, the content may be received in HTML format and may be received through a transceiver of the user device The translation engine may determine if the content requires translation (block 520) For example, if the content is associated with a web service which is available in a mobile format, no translation may be required. Otherwise, if the content is associated with a legacy web service, for example, the process may proceed to block 530, and a translation pattern from a set of patterns may be identified as corresponding to the content and/or the web service.

The translation engine may use the content and the translation pattern corresponding to the content to generate translated content (block 540). For example, as described above with reference to FIG. 4, the translated content may be in JSON format for presentation on the user device The translated client request may then be provided for presentation on the user device (block 550)

In various examples, the translator may generate the translated content in a variety of manners In one example, the patterns may be defined for particular web pages and/or requirements For example, the patterns may define a prefix tag or a suffix tag for the web page. The translator may first filter the HTML code from the web service by the prefix and/or suffix tag. Further, various patterns may be defined by particular attributes, and the translator may parse the HTML code from the web service according to the particular attributes The result of the translator is a mobile-friendly presentation to the user.

Thus, various examples of the present disclosure provide translation between a mobile platform and legacy web service, for example Further, as noted above, various examples of the translation engine are provided on the user device. In this regard, no intermediate service or server is required for translation Instead, translation patterns may be provided by the web service or by third parties and made available to the translator or translation engine

Thus, in accordance with the various examples described herein, a memory area may be provided that may have any arbitrary number of data segments and the data segments may be of any arbitrary size This allows the memory area to be extensible and compatible with a variety of protocols, standards or formats

The various examples set forth herein are described in terms of example block diagrams, flow charts and other illustrations Those skilled in the art will appreciate that the illustrated examples and their various alternatives can be implemented without confinement to the illustrated examples For example, block diagrams and their accompanying description should not be construed as mandating a particular architecture or configuration

What is claimed is:

1. A device, comprising
a processor, and
at least one memory unit coupled to the processor, the memory unit including a translation engine to.
receive input associated with a legacy web service,
identify a translation pattern corresponding to the input from a plurality of translation patterns, and
(a) when the input is from a user of the device, generate a translated client request based on the input and the translation pattern corresponding to the input, or
(b) when the input is from the legacy web service, generate a translated content based on the input and the translation pattern corresponding to the input.

2. The device of claim 1,
wherein the input is from a user of the device,
wherein the device is a mobile device,
wherein the input is based on a mobile representation of the legacy web service, and
the translated client request is a legacy client request.

3. The device of claim 1,
wherein the input is from the legacy web service,
wherein the device is a mobile device;
wherein the input is legacy content, and
the translated content is a mobile representation of the legacy content.

4. The device of claim 1, wherein at least some of the plurality of translation patterns are provided on the memory unit

5. The device of claim 1, wherein each translation pattern of the plurality of translation patterns corresponds to a web page of a web service

6. The device of claim 1, wherein the input is from a user of the device; and
wherein the translation pattern corresponding to the input formats the input according to the web service such that the translated client request appears as a client request from a legacy device.

7. A method, comprising
receiving, by a translator on a user device, a client request from a user of the user device, the client request being associated with a web service,
identifying a translation pattern corresponding to the client request from a plurality of translation patterns,
generating a translated client request based on the client request and the translation pattern corresponding to the client request, and
transmitting the translated client request to the web service

8. The method of claim 7,
wherein the user device is a mobile device,
wherein the web service is a legacy web service,
wherein the client request is based on a mobile representation of the legacy web service, and
the translated client request is a legacy client request

9. The method of claim 7, wherein the client request is received through a browser of the user device and the translator is a plug-in for the browser

10. The method of claim 7, wherein at least some of the plurality of translation patterns are provided on the user device

11. The method of claim 7, wherein each translation pattern of the plurality of translation patterns corresponds to a web page of a web service.

12. The method of claim 7, wherein the translation pattern corresponding to the client request formats the client request according to the web service such that the translated client request appears as a client request from a legacy device.

13. A method, comprising
receiving, by a translator on a user device, content from a web service,
identifying a translation pattern corresponding to at least one of the web service or the content from a plurality of translation patterns;
generating a translated content based on the content from the web service and the translation pattern corresponding to the at least one of the web service or the content, and
providing the translated content for display on the user device

14. The method of claim 13,
wherein the user device is a mobile device;
wherein the web service is a legacy web service;
wherein the content is legacy content, and
the translated content is a mobile representation of the legacy content.

15. The method of claim 13, wherein the translated content is displayed on the user device through a browser of the user device and the translator is a plug-in for the browser.
